(19) United States
(12) Patent Application Publication
(10) Pub. No.: US 2002/0154901 A1
(43) Pub. Date: Oct. 24, 2002

(54) Video/audio information recording/reproducing system

(76) Inventor: Ming-Teh Ho, Taipei (TW)

Correspondence Address: Joseph A. Mahoney, Mayer, Brown & Platt, P.O. Box 2828, Chicago, IL, 60690, US

(21) Appl. No.: 09/925,870

(22) Filed: Aug. 9, 2001

(30) Foreign Application Priority Data
Apr. 19, 2001 (TW) 090206156

(51) Int. Cl. H04N 5/92; H04N 5/781

(52) U.S. Cl. 386/98; 386/126

(57) ABSTRACT

A video/audio information recording/reproducing system is provided for recording an video information and an audio information onto a high-density optical record medium, such as CD-R, CD-RW, DVD-R, DVD-RW or DVD-RAM, and accessing and reproducing the video/audio information from the optical record medium. The system has an information recording apparatus for processing the inputted video information and the inputted audio information, multiplexing the processed video information and the processed audio information together with a reproducing program to generate a record information, and recording the record information onto said optical record medium. The system also has an information reproducing apparatus for accessing the record information recorded on said optical record medium, retrieving the reproducing program, the processed video information and the processed audio information from the record information, executing the reproducing program, and reproducing the inputted video information and the inputted audio information by the reproducing program.

### FIELD OF THE INVENTION

The present invention relates to a video/audio information recording/reproducing system and, more particularly, to a video/audio information recording/reproducing system for recording an video information and an audio information onto a high-density optical record medium, such as CD-R, CD-RW, DVD-R, DVD-RW or DVD-RAM, and accessing and reproducing the video/audio information from the optical record medium.

### BACKGROUND OF INVENTION

High-density optical record medium, such as CD-R or DVD-R, having an advantage of recording a large number of data is commonly employed to record video/audio information and serve as a record medium of an video/audio information recording/producing system. Generally, the video/audio information recording/producing system has an information recording apparatus (a writing-recording means) and an information reproducing apparatus (a playing means). The information recording apparatus processes and transforms the video/audio information into a digital information, and then codes and multiplexes the digital information. Thereafter, a record information is generated and recorded onto the optical record medium. The information reproducing apparatus accesses the record information from the optical record medium and then reproduces the video/audio information.

In order to solve problems of audio frequency information and playing speed caused by multinational languages, the conventional information recording apparatus, such as DVD-R, multiplexes an user information or controlling parameters together with the video/audio information. The related references are shown in U.S. Pat. Nos. 5,914,921, 5,805,537 and 5,715,355.

The conventional information reproducing apparatus may be a stand-alone playing means or a PC (personal computer) with a CD-ROM driver. In the stand-alone playing means, the function of reproducing information must cooperate with the function of recording information in the information recording apparatus. For example, when the information recording apparatus is used to execute a MPEG coding, the stand-alone playing means must have a function of MPEG coding. When the information reproducing apparatus is the PC with a CD-ROM driver, a reproducing program (a playing software) installed in the PC is required for successively reproducing the video/audio information.

### SUMMARY OF INVENTION

It is a principle object of the invention to modify an information recording apparatus of a video/audio information recording/reproducing system, thus an optical record medium on which the video/audio information has been recorded by the information recording apparatus can play in a stand-alone playing means. Also, the optical record medium can successively play in a CD-ROM driver disposed on a PC without installing play software.

Yet another object of the invention is to provide the information recording apparatus with a human-machine operating interface to the user for selecting the needed play programs in accordance with the reproducing quality and the whole performance of a PC when the information reproducing apparatus is the PC with a CD-ROM driver. Thereafter, the selective play program is recorded together with the inputted video/audio information onto the optical record medium. In addition, according to the evolution of the coding and the innovation of the drawing quality prediction mode, there is just a need of renewing the stored play program. This increases the compatibility of the information reproducing apparatus and the evolutional coding, the simplification of the designed circuits, and the quality of reproducing the video/audio information.

Accordingly, the present invention provide a video/audio information recording/reproducing system for recording an inputted video information and an inputted audio information onto an optical record medium, and accessing and reproducing the inputted video information and the inputted audio information from said optical record medium. The system comprises an information recording apparatus for processing the inputted video information and the inputted audio information, multiplexing the processed video information and the processed audio information together with a reproducing program to generate a record information, and recording the record information onto said optical record medium. The system also comprises an information reproducing apparatus for accessing the record information recorded on said optical record medium, retrieving the reproducing program, the processed video information and the processed audio information from the record information, executing the reproducing program, and reproducing the inputted video information and the inputted audio information by the reproducing program.

In the first embodiment of the present invention, the information recording apparatus comprises a first processor for applying a first predetermined process to the inputted video information to generate a processed video information, a second processor for applying a second predetermined process to the inputted audio information to generate a processes audio information, a storage means for storing the reproducing program, a multiplexer for multiplexing the processed video information, the processed audio information and the reproducing program together to generate the record information, and a record means for recording the record information onto said optical record medium.

In the second embodiment of the present invention, the information recording apparatus comprises a first processor for applying a first predetermined process to the inputted video information to generate a processed video information, a second processor for applying a second predetermined process to the inputted audio information to generate a processes audio information, a storage means for storing the plurality of reproducing programs, a control means, operated by a user-selective information, for selecting one from the plurality of reproducing programs as the selected reproducing program, a multiplex means for multiplexing the processed video information, the processed audio information and the selected reproducing program together to generate the record information, and a record means for recording said record information onto the optical record medium.

The advantage and spirit of the invention may be understood by the following recitations together with the appended drawings.

### BRIEF DESCRIPTION OF THE APPENDED DRAWINGS

FIG. 1 is a schematic diagram showing a video/audio information recording/reproducing system according to the first embodiment of the present invention.

FIG. 2 is a schematic diagram showing a video/audio information recording/reproducing system according to the second embodiment of the present invention.

### DETAILED DESCRIPTION OF THE INVENTION

The present invention provides a video/audio information recording/reproducing system for recording an inputted video information and an inputted audio information onto an optical record medium, such as DVD-R, and then accessing and reproducing the inputted video information and the inputted audio information from the optical record medium. By modifying an information recording apparatus of the video/audio information recording/reproducing system, the optical record medium on which video/audio information has been recorded by the information recording apparatus can play in a stand-alone playing means. Also, the optical record medium can successively play in a PC with a CD-ROM driver without installing any playing software.

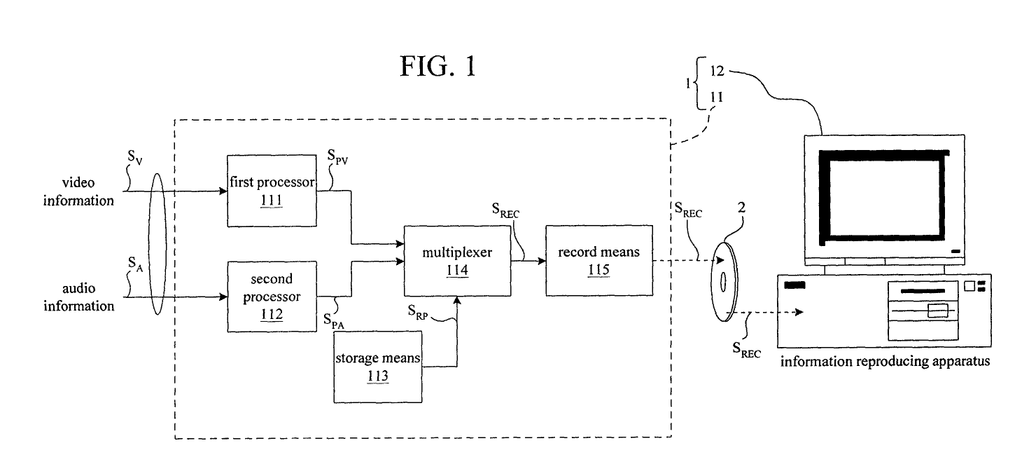

FIG. 1 is a schematic diagram showing a video/audio information recording/reproducing system 1 according to the first embodiment of the present invention. The video/audio information recording/reproducing system 1 comprises an information recording apparatus 11 and an information reproducing apparatus 12. In the information recording apparatus 11, an inputted video information S_{V} and an inputted audio information S_{A} are processed to generate a processed video information S_{PV} and a processed audio information S_{PA}. Then, the processed video information S_{PV} and the processed audio information S_{PA} are multiplexed together with a reproducing program S_{RP}(a playing program) so as to generate a record information S_{REC}. Next, the record information S_{REC} is recorded onto an optical record medium 2, such as DVD-R. In the information reproducing apparatus 12, the record information S_{REC} is accessed from the optical record medium 2, and then the processed video information S_{PV}, the processed audio information S_{PA} and the reproducing program S_{RP} are retrieved. Next, by executing the reproducing program S_{RP}, the inputted video information S_{V} and the inputted audio information S_{A} are reproduced.

According to the first embodiment of the present invention, the information recording apparatus 11 comprises a first processor 111, a second processor 112, a storage means 113, a multiplexer 114 and a record means 115.

The first processor 111 applies a first predetermined process to the inputted video information S_{V} to generate the processed video information S_{PV}. In one specific embodiment, the first predetermined process comprises a MPEG coding.

The second processor 112 applies a second predetermined process to the inputted audio information S_{A} to generate the processed audio information S_{PA}. In one specific embodiment, the second predetermined process comprises a MPEG coding. In another specific embodiment, the second predetermined process comprises a liner PCM coding. In the other specific embodiment, the second predetermined process comprises a AC-3 coding.

The storage means 113 stores the reproducing program S_{RP}. The multiplexer 114 multiplexes the processed video information S_{PV}, the processed audio information S_{PA} and the reproducing program S_{RP} to generate the record information S_{REC}. The record means 115 records the record information S_{REC} onto the optical record medium 2.

In practical applications, the information recording apparatus 11 is a stand-alone apparatus, such as a DVD recorder. The reproducing program S_{RP} is burn in the root of the optical record medium 2, such as DVD-R. The information reproducing apparatus 12 may be a stand-alone playing means or a PC with a CD-ROM driver. When the information reproducing apparatus 12 is a stand-alone playing means, such as a DVD playing means, the reproducing program S_{RP} cannot be executed by the information reproducing apparatus 12. When the information reproducing apparatus 12 is a PC with a CD-ROM driver, the reproducing program S_{RP} can close another reproducing program that is executing by the information reproducing apparatus 12 and then reproduces the video/audio information. If there is no reproducing program originally installed in the information reproducing apparatus 12, the reproducing program S_{RP} can be immediately executed to reproduces the video/audio information.

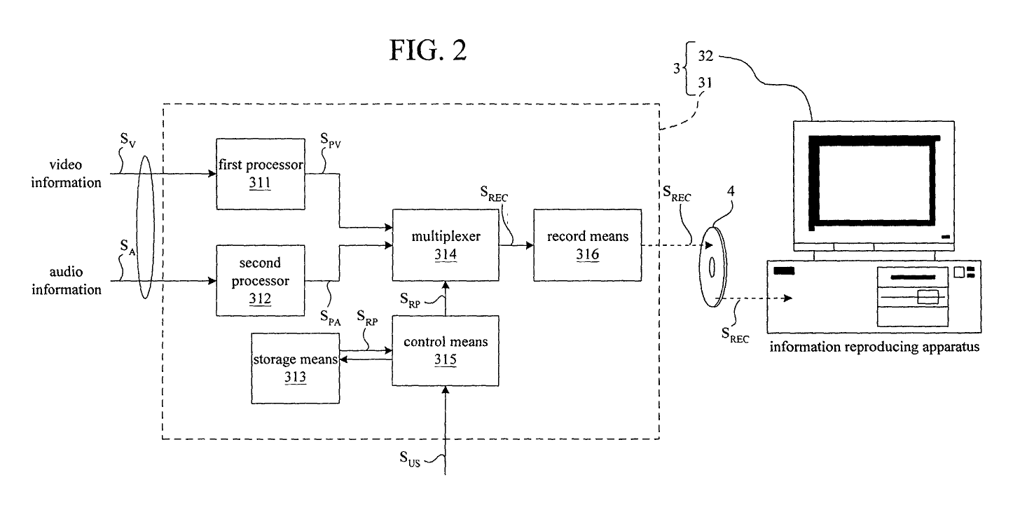

FIG. 2 is a schematic diagram showing a video/audio information recording/reproducing system 3 according to the second embodiment of the present invention. The video/audio information recording/reproducing system 3 comprises an information recording apparatus 31 and an information reproducing apparatus 32. The information recording apparatus 31 processes an inputted video information S_{V} and an inputted audio information S_{A} to generate a processed video information S_{PV} and a processes audio information S_{PA}. Then, the information recording apparatus 31 multiplexes the processed video information S_{PV}, the processes audio information S_{PA} and a selective reproducing program S_{RP} that is selected from a plurality of reproducing programs so as to generate a record information S_{REC}. Next, the information recording apparatus 31 records the record information S_{REC} onto an optical record medium 4, such as DVD-R. The information reproducing apparatus 32 accesses the record information S_{REC} from the optical record medium 4 to retrieve the processed video information S_{PV}, the processes audio information S_{PA} and the selective reproducing program S_{RP}. Then, by executing the reproducing program S_{RP}, the information reproducing apparatus 32 reproduces the inputted video information S_{V} and the inputted audio information S_{A}.

According to the second embodiment of the present invention, the information recording apparatus 31 comprises a first processor 311, a second processor 312, a storage means 313, a multiplexer 314, a control means 315 and a record means 316.

The first processor 311 applies a first predetermined process to the inputted video information S_{V} to generate the processed video information S_{PV}. In one specific embodiment, the first predetermined process comprises a MPEG coding.

The second processor 312 applies a second predetermined process to the inputted audio information S_{A} to generate the processed audio information S_{PA}. In one specific embodiment, the second predetermined process comprises a MPEG coding. In another specific embodiment, the second predetermined process comprises a liner PCM coding. In the other specific embodiment, the second predetermined process comprises a AC-3 coding.

The storage means 313 stores the plurality of reproducing programs. The control means 315 is operated by a user-selective information S_{US} to select the selective reproducing program S_{RP} from the plurality of reproducing programs. The multiplexer 314 multiplexes the processed video information S_{PV}, the processes audio information S_{PA} and the selective reproducing program S_{RP} to generate the record information S_{REC}. The record means 315 records the record information S_{REC} onto the optical record medium 4.

In practical applications, when the information reproducing apparatus 32 is a PC with a CD-ROM driver, the information recording apparatus 31 further provides a human-machine operating interface to the user for selecting the needed playing programs in accordance with the reproducing quality and the whole performance of the PC. Thereafter, the selective playing program is recorded together with the inputted video/audio information onto the optical record medium 4. In addition, according to the evolution of the coding and the innovation of the drawing quality prediction mode, there is just a need of renewing the stored playing program. This increases the compatibility of the information reproducing apparatus 32 and the evolutional coding, the simplification of the designed circuits, and the quality of reproducing the video/audio information.

While the invention has been described in several preferred embodiments, it is understood that the words which have been used are words of description rather than words of limitation and that changes within the purview of the appended claims may be made without departing from the scope and spirit of the invention in its broader aspect.

1. A video/audio information recording/reproducing system for recording an inputted video information and an inputted audio information onto an optical record medium, and accessing and reproducing the inputted video information and the inputted audio information from said optical record medium, said system comprising:
an information recording apparatus for processing the inputted video information and the inputted audio information, multiplexing the processed video information and the processed audio information together with a reproducing program to generate a record information, and recording the record information onto said optical record medium; and
an information reproducing apparatus for accessing the record information recorded on said optical record medium, retrieving the reproducing program, the processed video information and the processed audio information from the record information, executing the reproducing program, and reproducing the inputted video information and the inputted audio information by the reproducing program.

2. The video/audio information recording/reproducing system of claim 1, wherein said information recording apparatus comprises:
a first processor for applying a first predetermined process to the inputted video information to generate a processed video information;
a second processor for applying a second predetermined process to the inputted audio information to generate a processes audio information;
a storage means for storing the reproducing program;
a multiplexer for multiplexing the processed video information, the processed audio information and the reproducing program together to generate the record information; and
a record means for recording the record information onto said optical record medium.

3. The video/audio information recording/reproducing system of claim 2, wherein the first predetermined process comprises a MPEG coding.

4. The video/audio information recording/reproducing system of claim 2, wherein the second predetermined process comprises a MPEG coding.

5. The video/audio information recording/reproducing system of claim 2, wherein the second predetermined process comprises an AC-3 coding.

6. The video/audio information recording/reproducing system of claim 2, wherein the second predetermined process comprises a linear PCM coding.

7. The video/audio information recording/reproducing system of claim 1, wherein the reproducing program is a selected reproducing program selected from a plurality of reproducing programs, and wherein said information recording apparatus comprises:
a first processor for applying a first predetermined process to the inputted video information to generate a processed video information;
a second processor for applying a second predetermined process to the inputted audio information to generate a processes audio information;
a storage means for storing the plurality of reproducing programs;
a control means, operated by a user-selective information, for s electing one from the plurality of reproducing programs as the selected reproducing program;
a multiplex means for multiplexing the processed video information, the processed audio information and the selected reproducing program together to generate the record information; and
a record means for recording said record information onto the optical record medium.

8. The video/audio information recording/reproducing system of claim 5, wherein the first predetermined process comprises a MPEG coding.

9. The video/audio information recording/reproducing system of claim 5, wherein the second predetermined process comprises a MPEG coding.

10. The video/audio information recording/reproducing system of claim 5, wherein the second predetermined process comprises an AC-3 coding.

11. The video/audio information recording/reproducing system of claim 5, wherein the second predetermined process comprises a linear PCM coding.

12. An information recording apparatus for recording an inputted video information and an inputted audio information onto an optical record medium, comprising:
a first processor for applying a first predetermined process to the inputted video information to generate a processed video information;
a second processor for applying a second predetermined process to the inputted audio information to generate a processes audio information;
a storage means for storing a plurality of reproducing programs;
a control means, operated by a user-selective information, for selecting one from the plurality of reproducing programs;
a multiplex means for multiplexing the processed video information, the processed audio information and the selected reproducing program together to generate a record information; and
a record means for recording the record information onto the optical record medium.

13. The information recording apparatus of claim 12, wherein the first predetermined process comprises a MPEG coding.

14. The information recording apparatus of claim 12, wherein the second predetermined process comprises a MPEG coding.

15. The information recording apparatus of claim 12, wherein the second predetermined process comprises an AC-3 coding.

16. The information recording apparatus of claim 12, wherein the second predetermined process comprises a linear PCM coding.
